(19) United States
(12) Patent Application Publication
(10) Pub. No.: US 2007/0143826 A1
(43) Pub. Date: Jun. 21, 2007

(54) Method, apparatus and system for providing stronger authentication by extending physical presence to a remote entity

(76) Inventors: Manoj R. Sastry, Portland, OR (US); Michael J. Covington, Hillsboro, OR (US); Deepak J. Manohar, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/317,880

(22) Filed: Dec. 21, 2005

(51) Int. Cl. H04L 9/32

(52) U.S. Cl. 726/2

(57) ABSTRACT

A method, apparatus and system enable secure remote authentication. According to embodiments of the present invention, a remote administrator may be authenticated by accessing an approved secure location, transmitting location information with an access request and providing proof of physical presence in the access request. Additionally, in one embodiment, the location information and/or proof of presence may be signed by a security key to further tamper-proof the remote administrator's identity.

### BACKGROUND

Remote platform management enables information technology (“IT”) administrators to perform critical system tasks when they are not physically present at the client machine. As an increasing number of mobile devices are deployed in the workforce and/or sites supported by remote technical support staff become increasingly common, IT administrators are faced with an onslaught of complex device management issues, including software deployment, asset tracking, data protection, and remote troubleshooting and client support. Remote management technologies help to reduce support costs for platforms by enabling secure and reliable remote administration tools that do not require physical (on-site) access to the client.

Despite the many advantages of remote platform management, these technologies introduce a new vulnerability because they provide a new means for attackers to infiltrate the platform. Given that remote platform management includes critical administrative functions, any compromise of this capability will enable an adversary to gain complete control of the platform. They also package a tremendous amount of sensitive administrative functionality into a single management interface.

From a security perspective, it is desirable for a remote management solution to ensure the confidentiality and integrity of the data transmitted between the client and administrator. In addition, the remote management solution should ideally also provide strong user authentication. Typical existing solutions may provide some degree of confidentiality and integrity but they are forced to rely on simple, authentication techniques to verify the identity of remote administrators. These authentication mechanisms are therefore often easily forged or compromised by attackers. As a result of this vulnerability, remote management is currently not advisable or feasible for critical administrative tasks because they may leave the client completely exposed to attackers.

### BRIEF DESCRIPTION OF THE DRAWINGS

The present invention is illustrated by way of example and not limitation in the figures of the accompanying drawings in which like references indicate similar elements, and in which:

FIG. 1 illustrates a typical remote administration scheme;

FIG. 2 illustrates conceptually the components of an embodiment of the present invention; and

FIG. 3 is a flow chart illustrating an embodiment of the present invention.

### DETAILED DESCRIPTION

Embodiments of the present invention provide a method, apparatus and system for enhanced secure remote authentication by extending physical presence to a remote entity. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

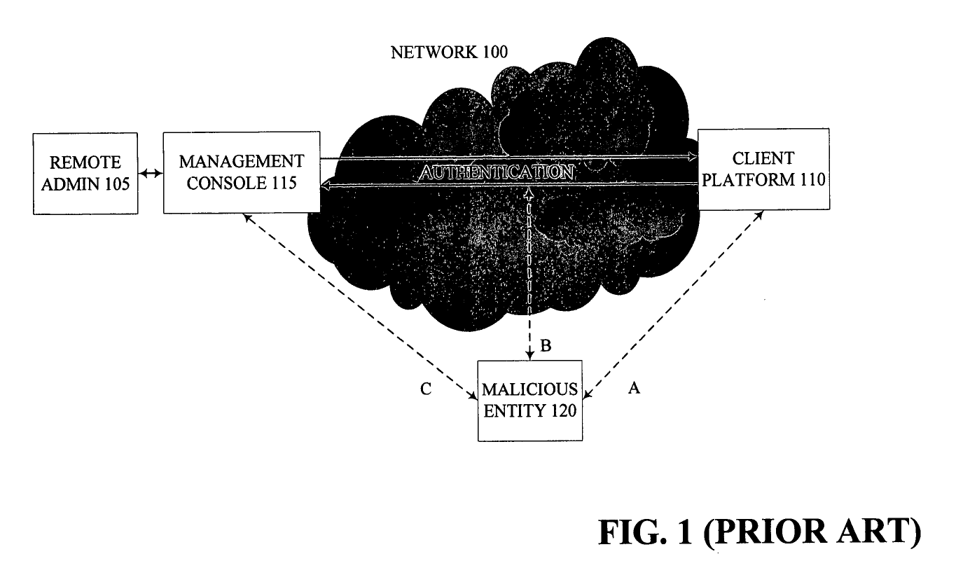

In order to facilitate understanding of embodiments of the present invention, FIG. 1 describes a typical remote administration scheme. As illustrated, an IT administrator (“Remote Admin 105”) may access a client device (“Client Platform 110”) from a management console (“Management Console 115”) over a network (“Network 100”). Malicious Entity 120 may attempt to compromise the security of Client Platform 110 in a variety of ways. First, as illustrated by arrow A, Malicious Entity 120 may attempt to hack directly into Client Platform 10. Alternatively, Malicious Entity 120 may attempt to impersonate a legitimate Remote Admin 105 by either gaining access to Remote Admin 105's authentication mechanism and/or by attacking Remote Admin 105 directly, i.e., by gaining access to Management Console 115 and thereafter impersonating a legitimate Remote Admin 105.

Certain authentication schemes rely on a simple username/password entry to provide access to Client Platform 110. Various other authentication mechanisms such as Transport Layer Security (“TLS”) or Hypertext Transfer Protocol (“HTTP”) authentication typically depend on a secret (e.g., a secret key) to uniquely identify Remote Admin 105, but these schemes are only as secure as the secret or security keys used to enforce the mechanism. In other words, if Malicious Entity 120 gains access to the security keys, that party may act as an administrator, unbeknown to Client Platform 110. Similarly, Malicious Entity 120 may attempt to gain access to Management Console 115 directly, thus allowing the party to act as a remote administrator. Remote administration is therefore currently open to various malicious attacks that may compromise the security of the remote devices. As a result, current remote administration tools may still require the administrator's physical presence at Client Platform 110 to perform platform critical tasks.

Embodiments of the present invention provide a secure remote authentication scheme that extends the physical presence of an administrator to a remote entity. More specifically, embodiments of the present invention enable a remote administrator to securely perform critical administrative tasks on a platform. Thus, embodiments of the invention provide Client Platform 110 with a higher level of assurance in the identity of Remote Admin 105 by requiring Remote Admin 105 to essentially prove his or her identity and that he or she is live at a predetermined “approved location”. The concept of approved locations is described in further detail later in the specification.

Thus, for example, consider a scenario in which Client Platform 110 resides in a remote field office and is having difficulty booting up because its operating system (“OS”) image has been damaged by a virus. Typically, a local IT administrator in the field office may fix the problem by physically accessing the machine (i.e., directly accessing Client Platform 110). Alternatively, a remote administrator (Remote Admin 105), located at a corporate headquarters hundreds of miles away, may connect to the infected device from Management Console 115, complete a simple authentication process as described above (provide a username/password and/or a security key), and gain access to Client Platform 110. As previously discussed, this latter remote scheme is extremely vulnerable to attack, and given the critical nature of the problem, leaves Client Platform 110 open to various types of attacks by malicious entities.

According to embodiments of the present invention, however, remote administration may be utilized to resolve the problems on Client Platform 110 with a high degree of security. Specifically, in order to verify Remote Admin 105's authenticity, additional tiers of information (over and above username/password and/or simple secret authentication) may be required to authenticate Remote Admin 105. Specifically, in one embodiment, the following information may be verified before access is granted to Remote Admin 105: i) identity (e.g., username/password) ii) physical location (e.g., approved location) and iii) physical presence (e.g., proof of physical presence at approved location). Remote Admin 105 may thus be authenticated by providing user credentials, location information and/or indication of physical presence on that platform. This multi-tiered authentication provides a significantly higher level security, by essentially extending the physical presence of Client Platform 110 to a remote entity. Thus, by requiring Remote Admin 105 to meet the criteria for each tier, i.e., “pass” each tier of authentication, Remote Admin 105 may securely access Client Platform 110 from a remote location.

In one embodiment, Remote Admin 105 may first be required to pass a physical access test, i.e., Remote Admin 105 may first gain access to an approved location. Approved locations may comprise various locations (e.g., a corporate IT server room, an IT administrative area in a hospital, etc.) that implement some form of physical security scheme (keys, card keys, retina scans, etc.). Even if the actual physical location (e.g., the corporate IT server room) does not implement a security scheme, entry to the building itself typically involves some form of physical security. As a result, the first tier of security essentially blocks unauthorized personnel from ever accessing an approved location. Upon entry into the secure location, Remote Admin 105 may utilize Management Console 115 to log into Client Platform 110 over Network 100. This login scheme may or may not be accompanied by a simple authentication scheme.

According to an embodiment of the present invention, however, simply logging into Client Platform 110 and providing user credentials and/or security keys may no longer be sufficient to gain access to Client Platform 110. Instead, in one embodiment, the simple authentication scheme typically used today may be supplemented by additional tiers of security designed to securely extend the physical presence of Client Platform 110 to a remote entity. Specifically, a variety of location sensing schemes may be utilized to determine location information for Management Console 115. This physical location information may be retrieved from the location sensing scheme by a process on Management Console 115 (described in further detail below), to be provided to Client Platform 110 as part of a remote access request from Management Console 115. Transmissions from Management Console 115 may be assumed to be transmitted from a “transmission module” and received on Client Platform 110 by a “receiving module”. Since any type of existing or future transmission and receiving schemes may be utilized without departing from the spirit of embodiments of the invention, these modules are omitted in the figures in order not to unnecessarily obscure embodiments of the invention.

If the physical location matches a location on a predefined dynamic list of approved locations maintained by Client Platform 110, Management Console 115 may “pass” the additional layer of security. Thus, for example, if a corporate IT server room in Santa Clara, Calif. is deemed an approved location, when Client Platform 110 receives the location information from Management Console 115, Client Platform 110 may compare the received physical coordinate location to determine whether it matches the physical coordinate location that it has for Santa Clara, Calif. If the coordinates match, then Client Platform 110 may determine that Remote Admin 105 is at an approved location.

Finally, to ensure that Remote Admin 105 is physically present and typing in commands at Management Console 115, one embodiment of the present invention may additionally ensure that Remote Admin 105 is physically entering information via the keyboard attached to Management Console 115. As previously discussed with respect to FIG. 1, one mechanism whereby Malicious Entity 120 may gain access to Client Platform 110 is by attacking Management Console 115 and thereafter impersonating a legitimate Remote Admin 105. Embodiments of the present invention address this issue by checking to ensure that Remote Admin 105 is physically present and entering information via the keyboard attached to Management Console. Schemes to determine physical presence includes schemes to identify input from a keyboard, i.e., denoting a physical presence at the keyboard. Since these schemes are well known to those of ordinary skill in the art, further description thereof is omitted herein in order not to unnecessarily obscure embodiments of the present invention. According to one embodiment of the invention, the combination of physical security, physical location and physical presence in addition to existing authentication schemes (e.g., login authentication using username/password and/or security keys), ensures a significantly high degree of certainty in the identity of Remote Admin 105.

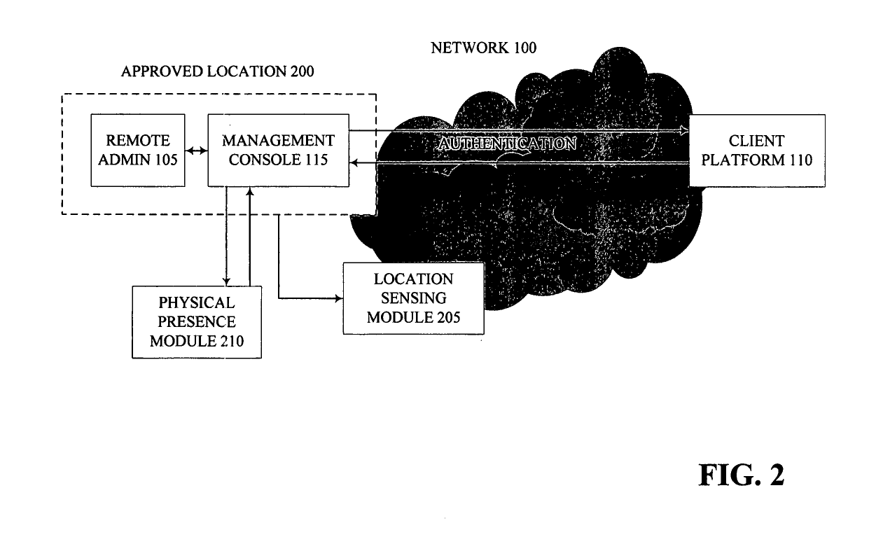

FIG. 2 illustrates conceptually an embodiment of the present invention. As illustrated, one or more approved locations (hereafter collectively referred to as “Approved Location 200”) may be defined. An example of Approved Location 200 includes a corporate IT lab, which may require Remote Admin 105 to present a card to a card reader to gain entry. By gaining access to Approved Location 200, Remote Admin 105 may move on to the next tier of authentication after logging in to Client Platform 110 utilizing existing or future security schemes (e.g., username and password). In this next tier, a location sensing scheme (e.g., a triangulation scheme) performed, for example, by “Location Sensing Module 205” may determine the physical location of Management Console 115. An example of Location Sensing Module 205 includes a wireless transmission tower, but embodiments of the invention are not so limited. Thus, for example, in one embodiment, Location Sensing Module 205 may reside within Management Console 115. A trusted process (“Trusted Process 210”) on Management Console 115 may retrieve this location information and transmit the information to PC 100 with an access request. If the location information matches a location on the list of Approved Location 200 information available to Client Platform 110, Remote Admin 105 may be deemed to have passed this tier of authentication.

In one embodiment of the present invention, Trusted Process 210 may comprise a software process running on the OS on Management Console 115. Given that software processes are highly susceptible to tampering, however, in an alternative embodiment that provides a higher degree of security, the Trusted Process 210 may be a hardware-based solution. It will be readily apparent to those of ordinary skill in the art that hardware-based solutions typically provide a significantly higher degree of security because hardware is far more difficult to tamper with than software. Thus, for example, in one embodiment, Trusted Process 210 may execute within a Trusted Platform Module (“TPM”) or any other comparable trusted platform scheme. TPMs are defined by the Trusted Computing Group (“TCG”) and well known to those of ordinary skill in the art so further description thereof is omitted herein. Although examples hereafter may pertain to TPM (e.g., TPM commands and flags), it will be readily apparent to those of ordinary skill in the art that any other “root of trust” mechanism may be utilized to achieve the same results.

In one embodiment, an additional tier of authentication may exist on Management Console 115 to ensure that Remote Admin 115 is in fact physically present to administer Client Platform 110. As previously described, schemes to determine physical presence (illustrated as Physical Presence Module 210) includes schemes to identify input from a keyboard, i.e., denoting a physical presence at the keyboard. Information pertaining to this “proof of presence” may also be transmitted from Management Console 115 to Client Platform 110 with the access request, to confirm Remote Admin 105's presence at Management Console 115. Thus, according to embodiments of this multi-tier authentication scheme, Remote Admin 105 may be authenticated by a combination of access to an approved location, username/password (and/or security keys), location information for Management Console 115 and proof of presence to physically interact with Management Console 115.

According to embodiments of the present invention, additional measures may be implemented to further enhance the scheme described above. For example, in one embodiment, upon retrieval of location information from a location sensing scheme, Management Console 115 may “sign” the information prior to transmitting the information to Client Platform 110. This signature may, for example, comprise the public key of a corporation, thus verifying further to Client Platform 110 that the location information is in fact authentic.

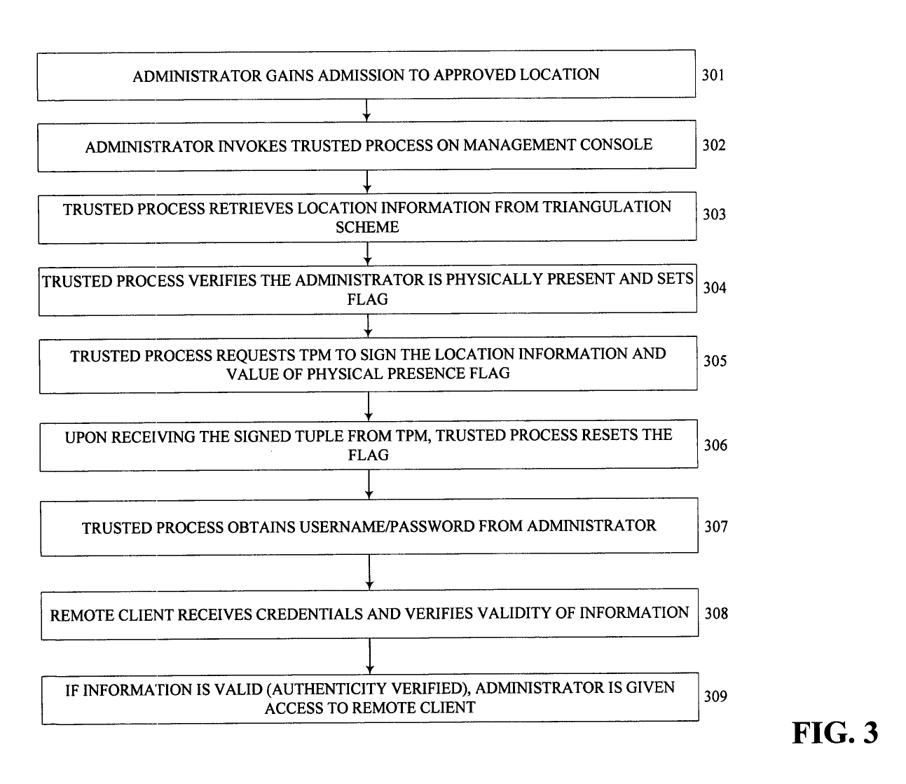

FIG. 3 is a flow chart illustrating an embodiment of the present invention. Although the following operations may be described as a sequential process, many of the operations may in fact be performed in parallel and/or concurrently. In addition, unless otherwise specified, the order of the operations may be re-arranged without departing from the spirit of embodiments of the invention. Although the following assumes the use of a TPM, embodiments of the invention are not so limited and other comparable trusted platform schemes may also be utilized. In 301, an IT administrator may gain access to a physically secure approved location. Upon gaining access, the IT administrator may then invoke a trusted process on a management console in 302 and the trusted process may retrieve the current management console location from a location sensing module in 303. In 304, the trusted process may verify that the administrator is physically present and invoke a TPM command (e.g., Tcsip_PhysicalPresence) to set a flag (e.g., TCPA_PHYSICAL_PRESENCE) inside the TPM to indicate the physical presence. Thereafter, the trusted process may request the TPM to sign the current machine location and also the value of the flag in 305. Upon receiving the signed information (e.g., in the form of a tuple {location, TCPA_PHYSICAL_PRESENCE}signed_TPM) from 305, the trusted process may reset the flag in 306.

In 307, the trusted process may obtain a username and password from the remote administrator and send the username and password, and the signed information ({location, TCPA_PHYSICAL_PRESENCE}signed_TPM) to the remote client's PC. When the remote client's PC receives the information or credentials in 308, it may validate the username and password, check the validity of the TPM signature on the tuple, check to determine if the location coordinates are inside an approved secure location and if the TCPA_PHYSICAL_PRESENCE flag was set. In 309, if authentication is successful, the remote administrator is given access to the PC to perform management functions remotely.

As previously described, embodiments of the present invention may provide significantly enhanced security to remote administration schemes to enable these schemes to securely provide remote access to critical functions on the client platform. Additionally, embodiments of the invention may enable features that were previously deemed too critical to allow for remote access and/or previously unavailable features of remote administration. For example, if Client Platform 110 incorporates technologies such as Intel® Corporation's Active Management Technologies (“AMT”), “Manageability Engine” (“ME”), Platform Resource Layer (“PRL”) and/or other comparable or similar technologies) and/or a virtualized environment (e.g., a virtual machine in Intel® Corporation's Virtualization Technology (“VT”) scheme), embodiments of the present invention may provide Remote Admin 105 with significantly enhanced capabilities to remotely manage Client Platform 110. For example, Remote Admin 105 may access Client Platform 110 in a pre-boot environment and determine which operating systems to launch.

Embodiments of the present invention may be implemented on a variety of computing devices. According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data. In alternate embodiments, the host bus controller may be compatible with various other interconnect standards including PCI, PCI Express, FireWire and other such existing and future standards.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising:
retrieving location information for a management console;
obtaining proof of physical presence at the management console; and
transmitting the location information and the proof of physical presence from the management console to a remote computing device.

2. The method according to claim 1 further including verifying access to an approved location.

3. The method according to claim 1 further comprising:
signing the location information and the proof of physical presence prior to transmitting to the remote computing device.

4. The method according to claim 1 wherein retrieving the location information further comprises retrieving the location information from a location sensing scheme.

5. The method according to claim 4 wherein the location sensing scheme is one of a wireless based scheme, a cellular based scheme and a satellite based scheme.

6. The method according to claim 1 wherein obtaining proof of physical presence at the management console further comprises verifying keystrokes from a keyboard coupled to the management console.

7. An article comprising a machine-accessible medium having stored thereon instructions that, when executed by a machine, cause the machine to:
retrieve location information for a management console;
obtain proof of physical presence at the management console; and
transmit. the location information and the proof of physical presence to a remote computing device.

8. The article according to claim 7 wherein the instructions, when executed by the machine, are further capable of causing the machine to sign the location information and the proof of physical presence prior to transmitting to the remote computing device.

9. The article according to claim 7, wherein the instructions, when executed by the machine, are further capable of causing the machine to retrieve the location information from a location sensing scheme.

10. The article according to claim 7 wherein the instructions, when executed by the machine, are further capable of causing the machine to obtain proof of physical presence at the management console by verifying keystrokes from a keyboard coupled to the management console.

11. A management console, comprising:
a location sensing module capable of retrieving location information for the management console;
a physical presence module capable of identifying proof of physical presence at the management console; and
a transmission module capable of transmitting the location information and the proof of physical presence to a remote computing device.

12. The management console according to claim 11 further comprising a security module capable of signing the location information and the proof of physical presence prior to transmission to the remote computing device.

13. The management console according to claim 11 further comprising a keyboard, the physical presence module further capable of obtaining proof of physical presence at the management console by verifying keystrokes from the keyboard.

14. A method, comprising:
verifying an identity of a remote administrator;
receiving transmission of a location and a proof of physical presence of the remote administrator.

15. The method according to claim 14 wherein verifying the identity of the remote administrator further comprises examining user credentials.

16. The method according to claim 15 wherein receiving transmission of the location and the proof of physical presence of the remote administrator further comprises receiving a signed transmission of the location and the proof of physical presence of the remote administrator.

17. A client platform, comprising:
a verification module capable of verifying an identity of a remote administrator; and
a receiving module capable of receiving location information and proof of physical presence of the remote administrator.

18. The client platform according to claim 17 wherein the verification module is capable of examining user credentials of the remote administrator.

19. The client platform according to claim 17 wherein the receiving module is further capable of receiving a signature with the location information and proof of physical presence of the remote administrator.

20. The client platform according to claim 19 further comprising a security module capable of examining the signature to authenticate the location information and the proof of physical presence of the remote administrator.
